(19) United States
(12) Patent Application Publication
(10) Pub. No.: US 2026/0213295 A1
(43) Pub. Date: Jul. 23, 2026

(54) A METHOD OF THERMAL MANAGEMENT OF A BATTERY

(71) Applicant: Perkins Engines Company Limited, Peterborough (GB)

(72) Inventors: Alexander Charles Brown, Spalding (GB); Stephen Adam Edwards, Peterborough (GB)

(21) Appl. No.: 19/144,068

(22) PCT Filed: Dec. 21, 2023
(86) PCT No.: PCT/EP2023/025555

§ 371 Date: Jun. 27, 2025

(30) Foreign Application Priority Data
Jan. 3, 2023 (GB) 2300026.8

(51) Int. Cl. H01M 10/633; B60L 58/12; B60L 58/27; H01M 10/48; H01M 10/615; H01M 10/625; H01M 10/6568; H01M 10/6572

(52) U.S. Cl. CPC H01M 10/633; H01M 10/486; H01M 10/615; H01M 10/625; H01M 10/6568; H01M 10/6572; B60L 58/12; B60L 58/27; B60L 2240/545; B60L 2240/549; H01M 2220/20

(57) ABSTRACT

A method of thermal management of a battery, wherein the battery comprises at least one cell and wherein a heating device is configured to heat the battery in response to a heating instruction. The method comprises determining a state of charge of the cell, a cell current of the cell; a first value of a first parameter of the heating device; a reference cell temperature of the cell; a maximum cell temperature and a minimum cell temperature of the cell. In an event that the maximum cell temperature is below a first threshold temperature; the minimum cell temperature of the cell is below a second threshold temperature; and the state of charge of the cell is above a threshold state of charge; the method further comprises instructing the heating device to heat the cell.

### FIELD OF THE DISCLOSURE

The disclosure relates to the field of thermal management.

### BACKGROUND

It is known that operating batteries within an optimal temperature range is beneficial for battery performance and for reducing degradation of the battery. Operating the battery outside of the optimal temperature range may increase the rate of deterioration of battery health. This may negatively impact the capacity, charge and discharge rate, life span, and other properties of the battery.

It is known to heat batteries using a heating device, for example a heater mat, to try to ensure that the batteries are within their optimal temperature range prior to or during operation. Conventionally, the heating device is turned on until a threshold temperature is reached, at which point the heating device is turned off. The measured temperature is usually the temperature at or near to the heating device, which may differ from the temperature of the battery cells.

### SUMMARY OF THE DISCLOSURE

Against this background, there is provided a method of thermal management of a battery, wherein the battery comprises at least one cell and wherein a heating device is configured to heat the battery in response to a heating instruction. The method comprises determining a state of charge of the cell; determining a cell current of the cell; determining a first value of a first parameter of the heating device; and determining a reference cell temperature of the cell. The method further comprises determining a maximum cell temperature and a minimum cell temperature of the cell by comparing the cell current and the first value of the first parameter to test data associating calibration values of the cell current and first parameter with one or more temperature errors. The method further comprises using the reference cell temperature, an ambient temperature, and a heat transfer coefficient of the heating device to determine a temperature of the heating device, and using the temperature of the heating device to determine a second value of the first parameter of the heating device. In an event that the maximum cell temperature is below a first threshold temperature; and the minimum cell temperature of the cell is below a second threshold temperature; and the state of charge of the cell is above a threshold state of charge; the method further comprises instructing the heating device to heat the cell.

In this way, it is possible to control the heating of the cell such that the cell is only heated when the cell temperature is in a range at which heating is required and safe. The heating of the cell may be further controlled such that heating takes place only if the state of charge of the battery is above a threshold, wherein the threshold may be a minimum state of charge that allows the machine powered by the battery to operate or to perform certain functions. For example, in an event that the battery powers an electric work vehicle, the state of charge threshold may be the minimum state of charge required for the electric work vehicle to travel to a charger. The method may allow the battery to be kept within a temperature range that is beneficial for reducing degradation or ageing of the battery and increases battery performance. The method may allow the heating to be controlled such that the heating device is enabled only when it is sufficiently beneficial and when it is safe to do so. Furthermore, the method may be carried out by an existing battery management software and controller, saving money and increasing ease of integration.

There is also provided a thermal management device for a battery, wherein the battery comprises at least one cell and wherein the thermal management device comprises a heating device configured to heat the battery in response to a heating instruction, and a controller. The thermal management device is configured to: determine a state of charge of the cell; determine a cell current of the cell; determine a first value of a first parameter of the heating device; and determine a reference cell temperature of the cell. The thermal management device is further configured to determine a maximum cell temperature and a minimum cell temperature of the cell by comparing the cell current and the first value of the first parameter to test data associating calibration values of the cell current and first parameter with one or more temperature errors. The thermal management device is further configured to use the reference cell temperature, an ambient temperature, and a heat transfer coefficient of the heating device to determine a temperature of the heating device, and use the temperature of the heating device to determine a second value of the first parameter of the heating device. In an event that: the maximum cell temperature is below a first threshold temperature; and the minimum cell temperature of the cell is below a second threshold temperature; and the state of charge of the cell is above a threshold state of charge; the thermal management device is further configured to instruct the heating device to heat the cell.

### BRIEF DESCRIPTION OF THE DRAWINGS

A specific embodiment of the disclosure will now be described, by way of example only, with reference to the accompanying drawings in which:

FIG. 1 shows a flow chart illustrating a thermal strategy logic according to an embodiment of the present disclosure.

FIG. 2 shows a flow chart illustrating a cell thermal model according to an embodiment of the present disclosure.

FIG. 3 shows a flow chart illustrating a heating device model according to an embodiment of the present disclosure.

FIG. 4 shows a flow chart illustrating a combined cell thermal model and heating device model according to an embodiment of the present disclosure.

FIG. 5 shows a flow chart illustrating a combined cell thermal model, heating device model and thermal strategy logic according to an embodiment of the present disclosure.

FIG. 6 shows a schematic diagram illustrating a battery module, heater mat and cooling plate for which a method according to an embodiment of the present disclosure may be carried out.

FIG. 7 shows a flow chart illustrating a heating device model according to an embodiment of the present disclosure. FIG. 7A shows the overall heating device model, FIG. 7B shows the heat rejection to a cell, and FIG. 7C shows heat rejection to ambient.

FIG. 8 shows a flow chart illustrating a thermal strategy logic according to an embodiment of the present disclosure.

FIG. 9 shows a flow chart illustrating a thermal strategy logic with hysteresis according to an embodiment of the present disclosure.

### DETAILED DESCRIPTION

A method of thermal management of a battery is provided, wherein the battery comprises at least one cell. The battery may comprise more than one cell. The battery may comprise one or more modules, wherein each module comprises one or more cells.

A heating device is configured to heat the battery in response to a heating instruction. The heating device may comprise any device that is configured to heat the battery, wherein the use of the heating device to heat of the battery can be controlled. For example, the heating device can start and stop heating the battery. In certain embodiments, the heating device comprises a heater mat configured to output heat when a current is applied. The heating mat may comprise a positive temperature coefficient (PTC) heater mat. The heater mat may be powered by the battery, so may draw current from the battery.

The method may allow the cell(s) of the battery to be kept within a certain temperature range, for example by enabling or disabling the heating device. The battery management system (BMS) may determine and/or implement the method of thermal management. In certain embodiments where the battery comprises more than one module, there may be a BMS per module wherein each BMS is configured to determine and/or implement the method of thermal management to the corresponding module of the battery. In certain embodiments where the battery comprises more than one module, there may be a heating device per module.

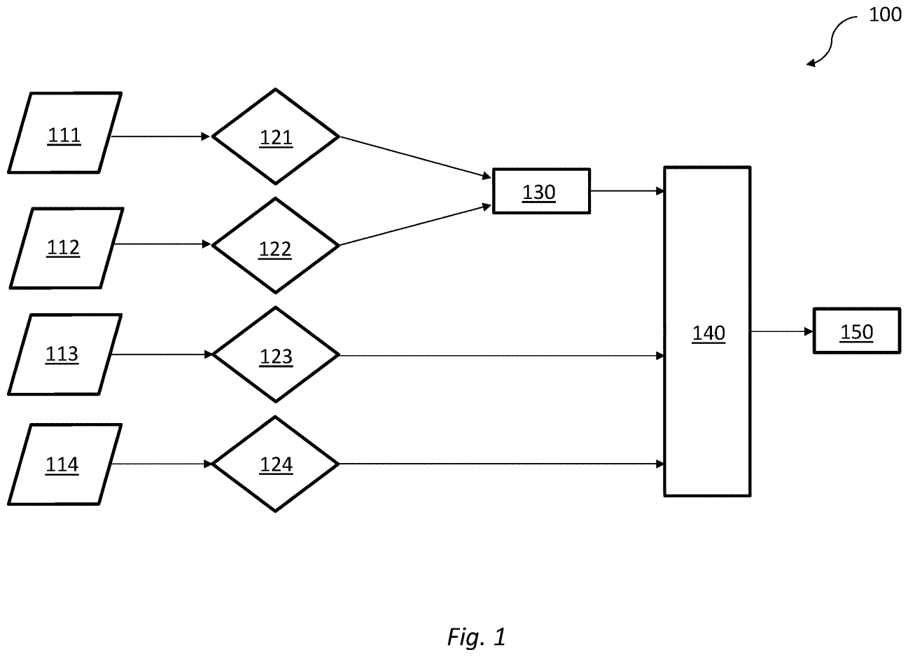

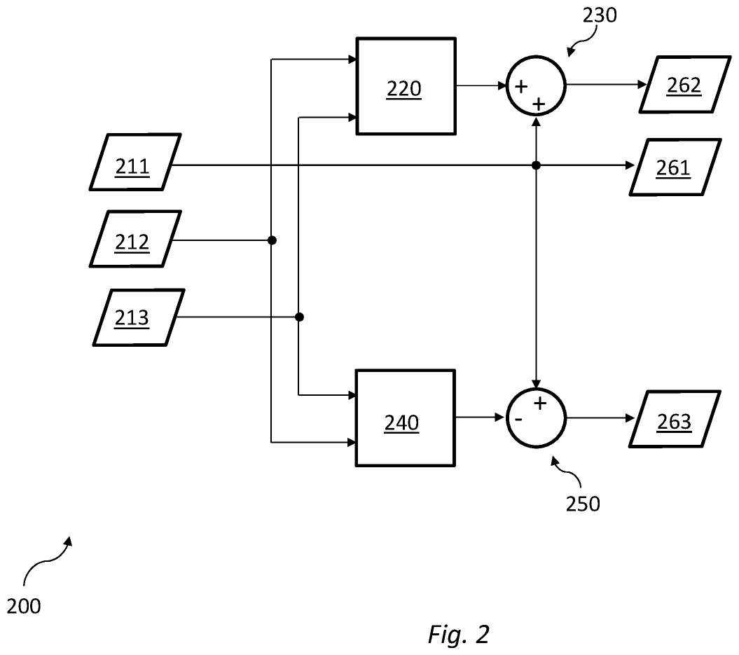

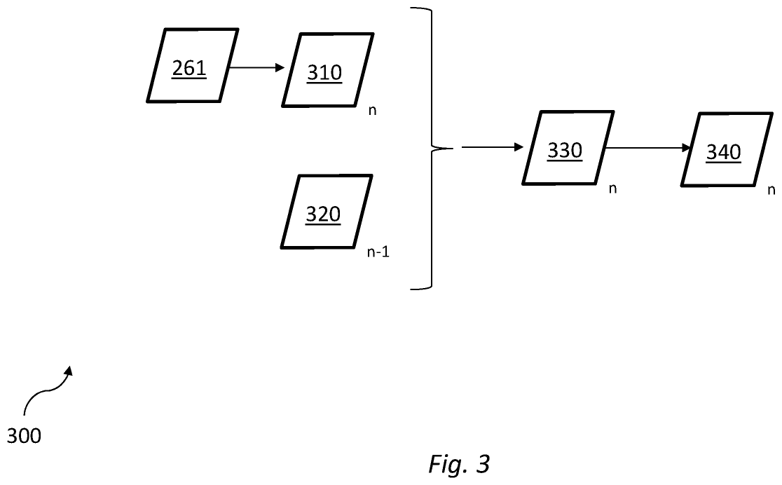

The method may comprise using a cell thermal model (see 200, FIG. 2), a heating device model (300, FIG. 3), and a thermal strategy logic (100, FIG. 1). The outputs of the cell thermal model 200 and heating device model 300 are used as inputs for the thermal strategy logic 100. The output of the thermal strategy logic 100 determines whether or not to instruct the heating device to output heat. In the following, enabling the heating device comprises using the heating device to output heat. Enabling the heating device may comprise instructing the heating device to start heating, instructing the heating device to continue heating, or providing no instruction in an event that the heating device is already heating.

The cell thermal model 200 may be configured to determine the maximum and minimum cell temperature of a battery module (wherein the battery may comprise one module or the battery may comprise more than one module, and wherein the battery module may comprise one or more cells). The maximum and minimum cell temperatures may take into account temperature errors. The cell thermal model 200 will be discussed in more detail below.

The heating device model 300 may be configured to determine a temperature of the heating device to use the temperature of the heating device to determine a value of a first parameter of the heating device. The first parameter may be indicative of the heat output of the heating device. For example, in an event that the heating device comprises an electric heater mat, the first parameter comprises a current. In an event that the heating device comprises an immersion heater or liquid coolant system, the first parameter may comprise the output of a temperature sensor.

With reference to FIG. 1, the thermal strategy logic 100 is illustrated. The maximum cell temperature 111, minimum cell temperature 112, the value of first parameter of the heating device 113, and a state of charge value 114 of the battery are used as inputs to the thermal strategy logic 100. In order for the thermal strategy logic 100 to determine that the heating device should be enabled, various conditions need to be met. The flow chart shown in FIG. 1 illustrates a situation where those conditions are met. The thermal strategy logic 100 compares the inputs to reference values or limits. The thermal strategy logic 100 may compare the maximum cell temperature to an upper temperature threshold at step 121, the minimum cell temperature to a lower temperature threshold at step 122, and the state of charge value to a state of charge threshold at step 124. At step 130, it is determined whether the maximum cell temperature is below the upper temperature threshold and the minimum cell temperature is below the lower temperature threshold. If both the maximum cell temperature is below the upper temperature threshold and the minimum cell temperature is below the lower temperature threshold, the method continues to step 140. At step 140, it is determined whether the state of charge value is above the state of charge threshold. If the state of charge value is above the state of charge threshold then the heating device may be enabled at step 150. In an event that any of those conditions are not met, then the heating device may not be enabled (even if the other conditions are met). Step 140 may further comprise, at step 123, comparing the first parameter value of the heating device 113 to a threshold when determining whether to enable the heating device. For example, in an event that the maximum cell temperature is below the upper temperature threshold, and the minimum cell temperature is below the lower temperature threshold, and the state of charge value is above the state of charge threshold, and the first parameter value is below a first parameter threshold, then the heating device may be enabled. Steps 121, 122, 123 and 124 may be carried out in parallel or in any order. Steps 130 and 140 may be combined, carried out in parallel or carried out in a different order.

In an embodiment, a method of thermal management of a battery is provided, wherein the battery comprises at least one cell and wherein a heating device is configured to heat the battery in response to a heating instruction. The method comprises determining a state of charge of the cell; determining a cell current of the cell; determining a first value of a first parameter of the heating device; and determining a reference cell temperature of the cell. The method further comprises determining a maximum cell temperature and a minimum cell temperature of the cell by comparing the cell current and the first value of the first parameter to test data associating calibration values of the cell current and first parameter with one or more temperature errors. The method further comprises using the reference cell temperature, an ambient temperature, and a heat transfer coefficient of the heating device to determine a temperature of the heating device, and using the temperature of the heating device to determine a second value of the first parameter of the heating device.

In an event that the maximum cell temperature is below a first threshold temperature, and the minimum cell temperature of the cell is below a second threshold temperature, and the state of charge of the cell is above a threshold state of charge, the method further comprises instructing the heating device to heat the cell. In an event that the heating device is not already enabled (i.e. not heating the cell), the step of instructing the heating device to heat the cell may comprise enabling the heating device. In an event that the heating device is enabled (i.e. already heating the cell), the step of instructing the heating device to heat the cell may comprise instructing the heating device to continue heating. If one or more of the conditions are not met, i.e. in an event that the maximum cell temperature is above a first threshold temperature, and/or the minimum cell temperature of the cell is above a second threshold temperature, and/or the state of charge of the cell is below a threshold state of charge, the method may further comprise instructing the heating device not to heat the cell. In an event that the heating device is already not heating the cell, the step of instructing the heating device not to heat the cell may comprise instructing the heating device to continue not heating the cell, or providing no instruction to the heating device. In an event that the heating device is enabled (i.e. already heating the cell), the step of instructing the heating device not to heat the cell may comprise instructing the heating device to stop heating the cell.

In certain embodiments, in an event that the maximum cell temperature is below a first threshold temperature, the minimum cell temperature of the cell is below a second threshold temperature, the state of charge of the cell is above a threshold state of charge, and the second value of the first parameter is below a threshold, the method comprises instructing the heating device to heat the cell.

Iterations of the method may be carried out at a plurality of time stamps during use of the battery. For example, the method may be carried out in a first iteration when the battery management system is turned on. The method may then be repeated in subsequent iterations at certain time intervals until the battery management system is turned off.

To aid explanation, the following description assumes that the heating device is an electric heater mat, such as a PTC heater mat, and that the first parameter is an input current of the heater mat. The heater mat is configured to emit heat in response to an input current. However, any heating device may be used, which may have different first parameters.

As described above, the method may use a cell thermal model 200, whereby the method comprises determining a maximum cell temperature and a minimum cell temperature of the cell by comparing the cell current and the first parameter to test data associating calibration values of the cell current and first parameter with one or more temperature errors (the cell thermal model). With reference to FIG. 2, a cell thermal model 200 according to certain embodiments of the disclosure is illustrated, wherein the heating device comprises an electric heater mat. The inputs to the cell thermal model 200 are a BMS temperature measurement 211, a cell current 212, and a first value 213 of the heater mat input current (i.e. a first value of the first parameter). The BMS temperature measurement 211 may comprise an output from one or more temperature sensors of the battery. In an event that the battery comprises more than one module, the BMS temperature measurement 211 may comprise an output from one or more temperature sensors of the module. The outputs of the cell thermal model 200 are a reference cell temperature 261, a maximum cell temperature 262 and a minimum cell temperature 263. The BMS temperature measurement 211 is used as the reference cell temperature. The cell current 212 and first value 213 of the heater mat input current are taken as inputs to calculate a positive temperature uncertainty at 220. The positive temperature uncertainty is added to the BMS temperature measurement 211 at 230, to provide the maximum cell temperature 262. The cell current 212 and first value 213 of the heater mat input current are taken as inputs to calculate a negative temperature uncertainty at 240. The negative temperature uncertainty is subtracted from the BMS temperature measurement 211 at 250, to provide the maximum cell temperature 262.

The positive and negative temperature uncertainties may be calculated at 220 and 240 using test data associating calibration values of the cell current and first parameter with one or more temperature errors. In other words, a calibrated error map is used to return temperature errors associated with the input cell current 211 and input heater mat current 213. The calibrated error map may be generated from test results. The errors may indicate expected variation of temperatures (for example between cells of a module, or uncertainties in heating a cell to a nominal temperature). The errors may also indicate errors in upstream measurements, for example measurements made by the BMS.

The method may use a heating device model, whereby the method uses the reference cell temperature, an ambient temperature, and a heat transfer coefficient of the heating device to determine a temperature of the heating device, and then uses the temperature of the heating device to determine a second value of the first parameter of the heating device. With reference to FIG. 3, a heating device model 300 according to certain embodiments of the disclosure is illustrated, wherein the heating device comprises an electric heater mat. FIG. 3 shows an n^{th} iteration of the heating device model 300. The heating device model 300 may be carried out at each of a plurality of sequential time stamps during use of the battery. The reference temperature 261 that was output from the cell thermal model 200 of FIG. 2 may be used as an input for temperature parameters 310 of the n^{th} iteration, wherein the temperature parameters 310 may include one or more of an average cell temperature, an ambient temperature and a heat transfer coefficient of the heating device. The average cell temperature may be an average of cell temperatures of a battery. For example, in an event that the battery comprises more than one cell, the average cell temperature may be the average of the reference cell temperature for each cell. In an event that the battery comprises more than one module and each module comprises more than one cell, the average temperature may comprise a module temperature (an average of the reference cell temperature for each cell of the module) or a battery temperature (an average of the module temperatures). The ambient temperature may be a temperature measured at the beginning of a use cycle of the battery, for example when the BMS is turned on. The ambient temperature may alternatively be a calibratable parameter that can be set by the BMS or by a user. The heat transfer coefficient may be a calibratable parameter that can be set by the BMS or by a user. The temperature parameters of the n^{th} iteration may be used, along with a heater mat power value of the (n−1)^{th} iteration of the heating device model, to calculate a temperature 330 of the heating device. From the temperature 330, a second value 340 of the first parameter of the heating device may be calculated. Where the heating device is an electric heater mat, the second value 340 of the input current of the heater mat is calculated.

The heating device model 300 may calculate the heating device temperature based on thermodynamic energy balancing. In an embodiment where the heating device comprises an electric heater mat, the heating device model may use the heating device temperature to calculate a heating device resistance value (for example, based on calibration data that corresponds resistance values to calibration heating device temperature values). The heating device resistance value may then be used to calculate the heater mat current, based on the voltage (wherein the voltage may be measured or calibratable). In an event that the heater mat is powered by the battery or battery module, the voltage may be the battery voltage or module voltage. The electric heater mat power may also be calculated, to be used as input 320 in the next iteration of the heating device model.

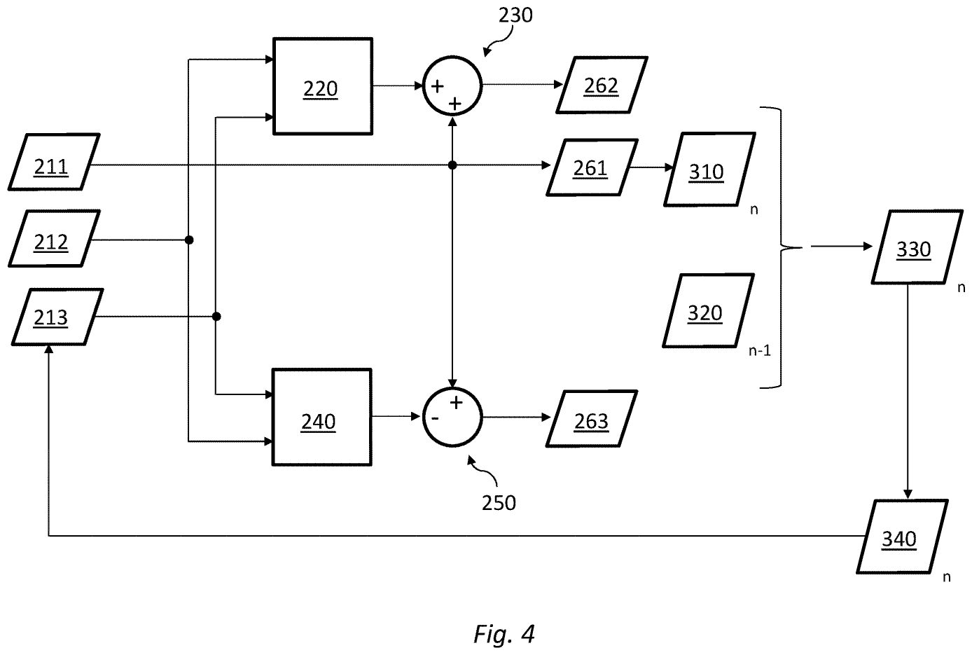

FIG. 4 illustrates the interaction between the cell thermal model 200 and the heating device model 300. The output reference cell temperature 261 may be used as an input to the temperature parameters 310 of the heating device model 300. The output second value 340 of the first parameter (such as input current) of the heating device may be fed into the next iteration of the cell thermal model 200 as input 213. In other words, the input 213 (the first value 213 of the heater mat input current) of the n^{th} iteration of the cell thermal model 200 is the output 340 (second value of the heater mat input current) of the (n−1)^{th} iteration of the heating device model 300. For the first iteration of the cell thermal model 200, the input 213 may be a calibration value or may be measured. For the first iteration of the heating device model 300, the input 320 may be a calibration value or may be measured.

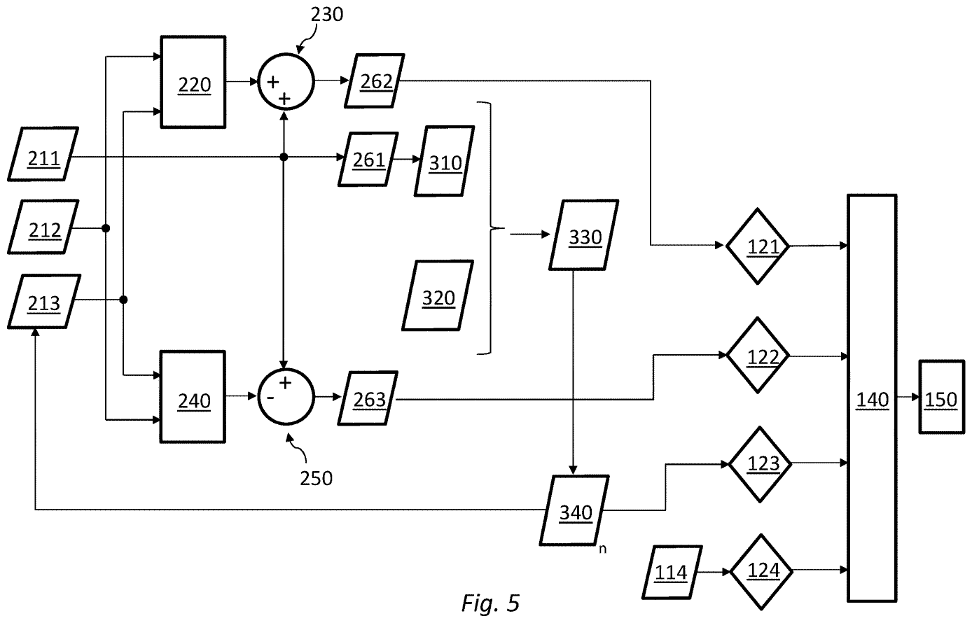

Referring back to FIG. 1, the maximum and minimum cell temperatures 111 and 112 may be the outputs 262 and 263 of the cell thermal model 200. The value of first parameter of the heating device 113 may be the output 340 of the heating device model 300. FIG. 5 illustrates how the cell thermal model 200, heating device model 300 and thermal strategy logic 100 may interact. The maximum cell temperature 262 is compared to an upper temperature threshold at step 121. The minimum cell temperature 263 is compared to a lower temperature threshold at step 122. The first parameter of the heating device is compared to a threshold at step 123. The state of charge value 114 is compared to a state of charge threshold at step 124. At step 140, if all conditions are met, the heating device is enabled at step 150.

As discussed above, the thermal strategy logic 100 may compare the maximum and minimum cell temperatures and the cell state of charge to reference values. In an event that all three comparisons determine that conditions for enabling heating have been met, the heating device may be enabled (if there are more than three conditions for enabling heating, the heating device may be enabled if all conditions are met). If one or more of the conditions is not met, then heating is not enabled.

Comparing the state of charge to a reference value (indicated by step 124 of FIGS. 1 and 5) may include comparing the minimum cell state of charge to a reference state of charge. If the minimum cell state of charge is above the reference state of charge, a state of charge condition has been met. If the minimum cell state of charge is below the reference state of charge, the state of charge condition has not been met and the heating device is not enabled. In an example, the reference state of charge may be 10% of the total capacity of the cell. In another example, the reference state of charge may be between 10% and 15% of the total capacity of the cell.

Comparing the maximum cell temperature to a reference value (indicated by step 121 of FIGS. 1 and 5) may include comparing the maximum cell temperature of a cell to an upper temperature threshold. If the maximum cell temperature of the cell is below the upper temperature threshold, an upper temperature condition has been met. If the maximum cell temperature of the cell is not below the upper temperature threshold, the upper temperature condition has not been met and the heating device is not enabled. A hysteresis may be applied to prevent the heating device from being enabled and turned off repeatedly when the maximum cell temperature is close to the upper temperature threshold (i.e. to prevent unnecessary actuations if the cell temperature fluctuates very close to the temperature threshold). In an example, the upper temperature threshold may be between 30° C. and 60° C. In an example, hysteresis of between 5° C. and 10° C. may be applied. In another example, hysteresis of between 5% and 10% of the upper temperature threshold may be applied.

Comparing the minimum cell temperature to a reference value (indicated by step 122 of FIGS. 1 and 5) may include comparing the minimum cell temperature of a cell to a lower temperature threshold. If the minimum cell temperature of the cell is below the lower temperature threshold, a lower temperature condition has been met. If the minimum cell temperature of the cell is not below the lower temperature threshold, the lower temperature condition has not been met and the heating device is not enabled. A hysteresis may be applied to prevent the heating device from being enabled and turned off repeatedly when the minimum cell temperature is close to the lower temperature threshold. In an example, the lower temperature threshold may be 10° C. In an example, the lower temperature threshold may be between 0° C. and 10° C. In an example, hysteresis of between 5° C. and 10° C. may be applied.

These comparisons may be carried out in any order or in parallel. If one condition is not met, the subsequent comparisons may not be made for that iteration of the method (or at that timestamp).

In embodiments where the heating device comprises an electric heater mat, the thermal strategy logic 100 may further comprise comparing the heater mat current to a threshold. This may comprise checking that the heater mat current is lower than a current threshold. Otherwise, this may comprise subtracting the heater mat current from a discharge current limit of the battery and checking that the current difference is above an operational current threshold, wherein the operational current threshold is the minimum discharge current that needs to be available for the machine that is being powered by the battery to operate.

The cell thermal model 200 may be carried out for a single cell, or for a battery module comprising more than one cell, or for a battery comprising more than one battery module wherein each battery module comprises more than one cell. Where the cell thermal model 200 is carried out for a single cell, the temperature uncertainties may be calculated based on test data corresponding to individual cell temperature errors associated with the value of the first parameter. The output maximum and minimum cell temperatures may reflect those expected errors. Where the cell thermal model 100 is carried out for a battery module comprising more than one cell, the temperature uncertainties may be calculated based on test data corresponding to variation of cell temperatures across the module associated with the value of the first parameter. For example, the cells within the module may be heated at different rates depending on location relative to the heating device, access to cooling, or other factors. The output maximum and minimum cell temperatures may be the expected maximum cell temperature of the plurality of cells and the maximum cell temperature of the plurality of cells respectively. Where the cell thermal model 200 is carried out for a battery comprising more than one battery module, the temperature uncertainties may be calculated based on test data corresponding to variation of cell temperatures within each module of the battery associated with the value of the first parameter. For example, the modules within the battery may be heated at different rates depending on location relative to the heating device, access to cooling, or other factors. The output maximum and minimum cell temperatures may be the expected maximum cell temperature of the plurality of modules and the maximum cell temperature of the plurality of modules respectively.

The heating device model 300 may take inputs of reference cell temperature from one or more cell thermal models carried out for a cell, or for a module, or for the battery.

The thermal strategy logic 100 may be carried out for a single cell, or for a battery module comprising more than one cell, or for a battery comprising more than one battery module wherein each battery module comprises more than one cell. Where the thermal strategy logic 100 is carried out for a single cell, the minimum cell state of charge, maximum cell temperature and minimum cell temperature that are used as inputs in the thermal strategy logic 100 may correspond to that particular cell. The maximum and minimum cell temperatures are the outputs from a cell thermal model 200 carried out for that cell (i.e. they are the reference cell temperature plus the positive uncertainty and minus the negative uncertainty, respectively). Where the thermal strategy logic 100 is carried out for a battery module comprising more than one cell, the minimum cell state of charge, maximum cell temperature and minimum cell temperature that are used as inputs in the thermal strategy logic 100 may correspond to the overall module. The minimum cell state of charge may be the lowest cell state of charge of the more than one cells. The maximum cell temperature used in the thermal strategy logic 100 may be largest output of cell thermal models 200 carried out individually for the more than one cells, or may be the output of a cell thermal model 200 carried out for the module as a whole (see above). The minimum cell temperature used in the thermal strategy logic 100 may be smallest output of cell thermal models 200 carried out individually for the more than one cells, or may be the output of a cell thermal model 200 carried out for the module as a whole (see above). Where the thermal strategy logic 100 is carried out for a battery comprising more than one module, the minimum cell state of charge, maximum cell temperature and minimum cell temperature that are used as inputs in the thermal strategy logic 100 may correspond to the overall battery. The minimum cell state of charge may be the lowest cell state of charge of the cells of the more than one module. The maximum cell temperature used in the thermal strategy logic 100 may be largest output of cell thermal models 200 carried out individually for the more than one cells, or may be largest output of cell thermal models 200 carried out for each module as a whole, or may be the output of a cell thermal model 200 carried out for the battery as a whole. The minimum cell temperature used in the thermal strategy logic 100 may be smallest output of cell thermal models 200 carried out individually for the more than one cells, or may be the largest output of cell thermal models 200 carried out for each module, or may be the output of a cell thermal model 200 carried out for the battery as a whole.

The thermal strategy logic 100 may also check values of override channels, contactor or relay states, current limits, or other parameters. Additionally, in certain embodiments the thermal strategy logic 100 may check that a bus contactor is closed, where the bus contactor needs to be closed for the heater mat to function. In certain embodiments the thermal strategy logic 100 may check that a bus disconnect warning is not active. In certain embodiments the thermal strategy logic 100 may check that the pre-charge completed successfully. The thermal strategy logic 100 may carry out other checks before enabling the heating device.

As discussed above, the cell thermal model 200, heating device model 300 and thermal strategy logic 100 may be carried out for a cell, a module or a battery. The heating device may be configured to heat a cell, a module or a battery. In an event that the heating device is configured to heat a cell or a module, there may be more than one heating device for the battery. For example, if a heating device is configured to heat a module and a battery comprises more than one module, there may be one heating device per module of the battery. In an event that each module comprises more than one cell, the method for thermal management of the module as a whole may take into account the minimum and maximum cell temperatures of each cell and/or the temperature differences across the more than one cell of the module. For example, the calculation of the uncertainties may take into account the temperature differences between the more than one cells of the module. However, the heating device may be enabled or turned off for the module as a whole.

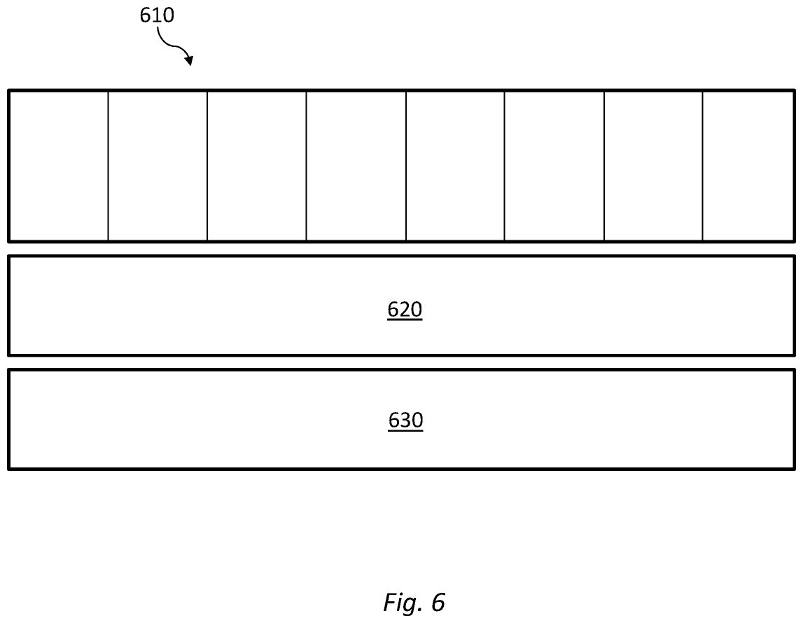

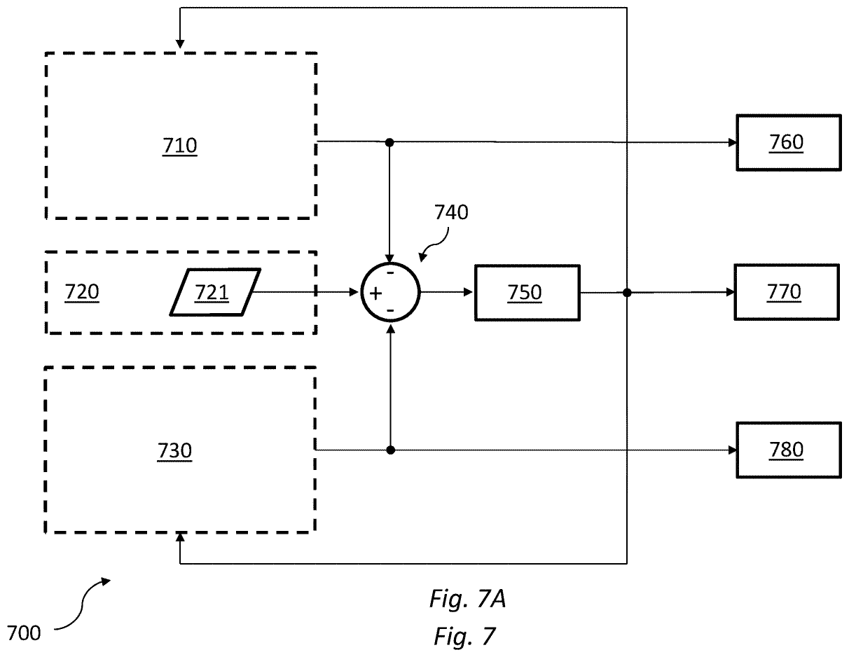

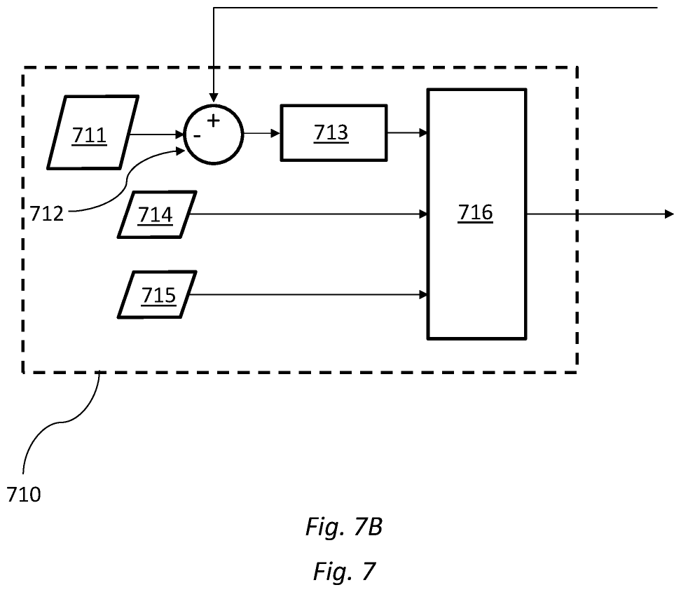

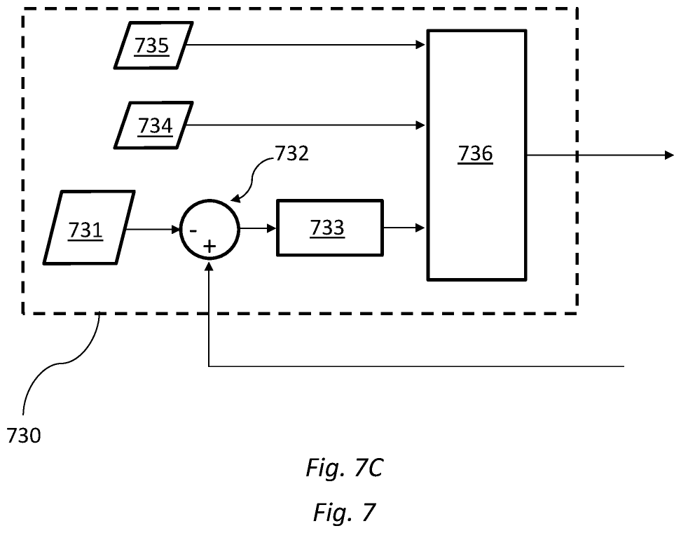

In certain embodiments, the heating device may comprise an electric heater mat such as a PTC heater mat. The battery may be passively cooled or actively cooled. There may additionally be a cooling system for the battery, such as a cooling plate or liquid coolant loop. In an event that the battery is passively cooled or in an event that the battery is actively cooled, the heating device model may further receive a coolant temperature and a coolant heat transfer coefficient as inputs. The heating device model may calculate input power to the heater mat, heat rejection to the battery cell or module, and heat rejection to the cooling system or to ambient. This will be described with reference to FIGS. 6 and 7.

As described above, the heating device model may estimate the heating device temperature via thermodynamic energy balancing. In an example where the heating device comprises a PTC electric heater mat, the heater mat may be assumed to be 2D. In this example the heat generation from the heater may be assumed to flow either to the cells or to a cooling path such as a cooling plate, and interaction of the heater mat with any housing or other component is ignored. This example is illustrated in FIG. 6, where a battery module 610 comprising cells is heated by heater mat 620, which lies between the module 610 and a coolant plate 630. Heat may transfer between the coolant plate 630 and the ambient atmosphere. The heat generated by the heater mat may be given by:

$${\dot{Q}}_{elec} = {I}_{PTC} {V}_{module}$$

where I_{PTC} is the current draw of the heater mat and V_{module} is the voltage of the battery module 610 (where the battery powers the heater mat). The heat transferred from the heater mat 620 to the module 610 may be given by:

$${\dot{Q}}_{heating} = {h}_{PTC cell} {A}_{PTC cell} ( {T}_{PTC} - {T}_{cell} )$$

where h_{PTC cell} is a heat transfer coefficient between the heater mat 620 and the cells of the module 610, A_{PTC cell} is the area of the interface between the heater mat 620 and the module 610, T_{PTC} is the temperature of the heater mat 620 and T_{cell} is the temperature of the module 610. Similarly, the heat transferred from the heater mat 620 to the cooling path via the cooling plate 630 may be given by:

$${\dot{Q}}_{cool} = {h}_{PTC amb} {A}_{PTC amb} ( {T}_{PTC} - {T}_{cell} )$$

where h_{PTC amb} is a heat transfer coefficient between the heater mat and the ambient atmosphere, A_{PTC amb} is the area of the interface between the heater mat 620 and the coolant plate 630, T_{PTC} is the temperature of the heater mat 620 and T_{amb} is the ambient temperature. T_{amb} may be measured when the battery management system is turned on. In an example, the battery may be used to power an electric vehicle, and T_{amb} may be measured at key-on of the vehicle.

With reference to FIG. 7, an example of a heating device model 700 is illustrated that incorporates heat rejection to ambient. The heating device model 700 is illustrated at a high level in FIG. 7A. The three main blocks are the heat rejection to the module or cell 710, the heater input power 720, and the heat rejection to ambient 730. Blocks 710 and 730 are shown in more detail in FIGS. 7B and 7C. Referring first to FIG. 7A, the block 710 may calculate \dot{Q}_{heating} as an output. This is passed to final output 760, which is the heat rejected to the cell (or module). Block 720 outputs the heating device input power 721. The block 730 may calculate \dot{Q}_{cool} as an output. This is passed to final output 780, which is the heat rejected to ambient or to a cooling path. At 740, the heat rejection to the cell \dot{Q}_{heating} and heat rejection to ambient \dot{Q}_{cooling} are subtracted from the input power to the heating device. The temperature of the heating device is calculated at 750. The temperature of the heating device is output at 770, and is also passed back to blocks 710 and 730. FIG. 7B illustrates block 710. An input may be a cell temperature 711, which at 712 is subtracted from the temperature of the heating device (passed back to the block from 750) to provide the temperature difference between the heating device and the cell at 713 (T_{PTC}−T_{cell}). At 716, \dot{Q}_{heating} is calculated using the temperature difference 713, the surface area of heating 714 (A_{PTC cell}), and the heat transfer coefficient between the heating device and the cell 715 (hh_{PTC cell}). FIG. 7C illustrates block 730. An input may be an ambient temperature 731, which at 732 is subtracted from the temperature of the heating device (passed back to the block from 750) to provide the temperature difference between the heating device and ambient at 733 (T_{PTC}−T_{amb}). At 736, \dot{Q}_{cooling} is calculated using the temperature difference 733, the surface area of heating 734 (A_{PTC amb}), and the heat transfer coefficient between the heating device and ambient 735 (h_{PTC amb}).

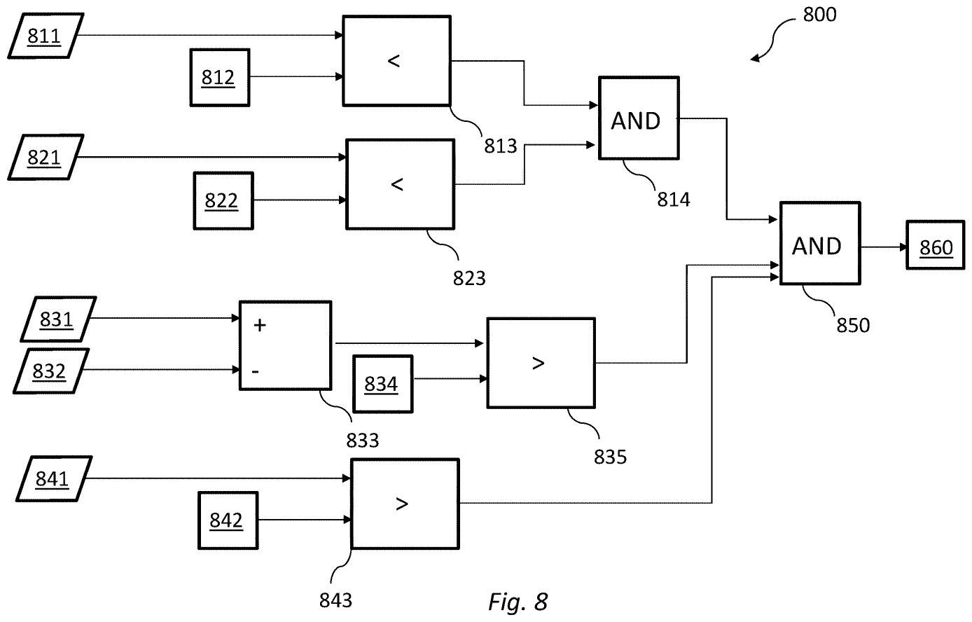

FIG. 8 illustrates an example of the thermal strategy logic 800, wherein the heating device comprises an electric heater mat and the first parameter is the heater mat current. Maximum cell temperature 811 is compared to an upper cell temperature threshold 812 at Boolean operation 813. “True” is output if the maximum cell temperature 811 is lower than the upper cell temperature threshold 812, and “false” is output if the maximum cell temperature 811 is higher than the upper cell temperature threshold 812. Minimum cell temperature 821 is compared to a lower cell temperature threshold 822 at Boolean operation 823. “True” is output if the minimum cell temperature 821 is lower than the lower cell temperature threshold 822, and “false” is output if the minimum cell temperature 821 is higher than the lower cell temperature threshold 822. Boolean operation 814 outputs “true” if both 813 and 823 output “true”, and outputs “false” if either or both of 813 and 823 output “false”. Heater mat current 832 is subtracted from a current limit 831 at 833. The current difference is compared to a current reserve 834 at Boolean operation 835. If the current difference is greater than the current reserve, “true” is output, and if the current difference is smaller than the current reserve, “false” is output. Minimum cell state of charge 841 is compared to a state of charge threshold 842 at Boolean operation 843. The operation 843 outputs “true” if the minimum cell state of charge 841 is greater than the state of charge threshold, and outputs “false” if the minimum cell state of charge 841 is lower than the state of charge threshold. Boolean operation 850 outputs “true” if operations 814, 835 and 843 all output “true”. If Boolean operation 850 outputs “true”, at 860 a signal is output to instruct the heater mat to heat the cell (or module). Boolean operation 850 outputs “false” if one or more of operations 814, 835 and 843 output “false”. If Boolean operation 850 outputs “false”, at 860 a signal is output to instruct the heater mat to not heat the cell (or module). Boolean operations 814 and 850 may occur in parallel or may be combined.

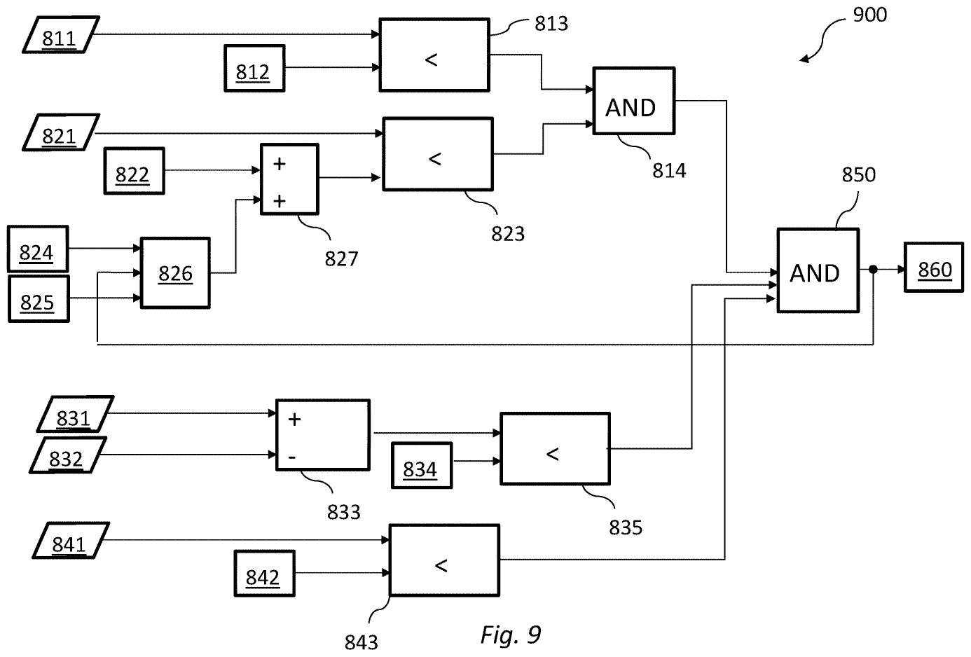

FIG. 9 illustrates a thermal strategy logic 900 that is similar to the thermal strategy logic 800 shown in FIG. 8, but adds hysteresis to the lower cell temperature threshold 822. Upper hysteresis limit 824 and lower hysteresis limit 825 are input to 826, along with the signal to the heater mat 860. The hysteresis calculated at 826 is added to the lower cell temperature threshold at 827. The sum is then input to operation 823. Hysteresis may also be added to the upper cell temperature threshold 812.

The heating device may comprise other heating devices instead of a heater mat, such as a thermoelectric heat pump (or Peltier heater), immersion heating, a liquid heating loop, or air heating. For example, immersion heating elements may use valves to control heating of individual battery modules. The method for these devices would be similar, but may use a different first parameter. The Peltier heater transfers heat from one side of the device to the other upon application of an electric current. The direction of heat transfer depends on the current direction. Typically, the Peltier heater comprises alternating p- and n-type semiconductors arranged between two thermally conducting plates. Similarly to the heater mat, the first parameter may comprise the applied current. The current may be compared to a threshold by the thermal strategy logic, wherein the current being below a threshold is a condition for enabling the heating device. For immersion heating, liquid heating loops or air heating, the first parameter may comprise a flow rate (flow regulation may occur via a valve) or an output from a temperature sensor.

A thermal management device for a battery is provided according to an embodiment of the disclosure, wherein the battery comprises at least one cell and wherein the thermal management device comprises a heating device configured to heat the battery in response to a heating instruction. The thermal management device further comprises a controller. The thermal management device is configured to carry out any of the methods discussed herein. The thermal management device may comprise a battery management system configured to determine the thermal strategy and control the heating device.

In a certain embodiment, the battery may be used to power an electric work vehicle. The battery may comprise more than one module, wherein each module comprises more than one cell and wherein each module is provided with a heating device. The battery management system may be configured to control each heating device separately.

1. A method of thermal management of a battery, wherein the battery comprises at least one cell and wherein a heating device is configured to heat the battery in response to a heating instruction, the method comprising:
determining a state of charge of the cell;
determining a cell current of the cell;
determining a first value of a first parameter of the heating device;
determining a reference cell temperature of the cell;
determining a maximum cell temperature and a minimum cell temperature of the cell by comparing the cell current and the first value of the first parameter to test data associating calibration values of the cell current and first parameter with one or more temperature errors; and
using the reference cell temperature, an ambient temperature, and a heat transfer coefficient of the heating device to determine a temperature of the heating device, and using the temperature of the heating device to determine a second value of the first parameter of the heating device;
wherein in an event that:
the maximum cell temperature is below a first threshold temperature;
the minimum cell temperature of the cell is below a second threshold temperature; and
the state of charge of the cell is above a threshold state of charge;
the method further comprises instructing the heating device to heat the cell.

2. The method of claim 1, wherein in event that:
the maximum cell temperature is below a first threshold temperature;
the minimum cell temperature of the cell is below a second threshold temperature;
the state of charge of the cell is above a threshold state of charge; and
the second value of the first parameter is below a threshold;
the method further comprises instructing the heating device to heat the cell.

3. The method of claim 1, wherein in an event that:
the maximum cell temperature is above a first threshold temperature; or
the minimum cell temperature of the cell is above a second threshold temperature; or
the state of charge of the cell is below a threshold state of charge;
the method further comprises instructing the heating device not to heat the cell.

4. The method of claim 1, wherein in an event that:
the maximum cell temperature is above a first threshold temperature; or
the minimum cell temperature of the cell is above a second threshold temperature; or
the state of charge of the cell is below a threshold state of charge; or
the second value of the first parameter is above a threshold;
the method further comprises instructing the heating device not to heat the cell.

5. The method of claim 1, wherein a hysteresis is added to the first threshold temperature.

6. The method of claim 1, wherein a hysteresis is added to the second threshold temperature.

7. The method of claim 1, wherein using the reference cell temperature, an ambient temperature, and a heat transfer coefficient of the heating device to determine a temperature of the heating device comprises calculating heat transfer from the heating device to the cell and calculating heat transfer from the heating device to ambient.

8. The method of claim 1, wherein the first parameter comprises an input current.

9. The method of claim 8 wherein the heating device comprises a heater mat configured to emit heat in response to an input current.

10. The method of claim 9 wherein the battery comprises one or more battery modules, each of the battery modules comprising more than one cell, and wherein the heating device comprises a heater mat per battery module, each heater mat configured to heat a battery module.

11. The method of claim 8 wherein the heating device comprises a thermoelectric heat pump.

12. The method of claim 1 wherein the heating device comprises a fluid heating system.

13. The method of claim 12 wherein the first parameter comprises a flow rate.

14. A thermal management device for a battery, wherein the battery comprises at least one cell and wherein the thermal management device comprises a heating device configured to heat the battery in response to a heating instruction, and a controller, wherein the thermal management device is configured to:
determine a state of charge of the cell;
determine a cell current of the cell;
determine a first value of a first parameter of the heating device;
determine a reference cell temperature of the cell;
determine a maximum cell temperature and a minimum cell temperature of the cell by comparing the cell current and the first value of the first parameter to test data associating calibration values of the cell current and first parameter with one or more temperature errors; and
use the reference cell temperature, an ambient temperature, and a heat transfer coefficient of the heating device to determine a temperature of the heating device, and use the temperature of the heating device to determine a second value of the first parameter of the heating device;
wherein in an event that:
the maximum cell temperature is below a first threshold temperature;
the minimum cell temperature of the cell is below a second threshold temperature; and
the state of charge of the cell is above a threshold state of charge;
the thermal management device is further configured to instruct the heating device to heat the cell.

15. The thermal management device of claim 14, wherein in event that:
the maximum cell temperature is below a first threshold temperature;
the minimum cell temperature of the cell is below a second threshold temperature;
the state of charge of the cell is above a threshold state of charge; and
the second value of the first parameter is below a threshold;
the thermal management device is further configured to instruct the heating device to heat the cell.
